(19) United States
(12) Patent Application Publication
(10) Pub. No.: US 2014/0244543 A1
(43) Pub. Date: Aug. 28, 2014

(54) Computer-Implemented Optimization of Retirement Income Sourcing

(71) Applicant: Paul R. Samuelson, West Newton, MA (US)

(72) Inventor: Paul R. Samuelson, West Newton, MA (US)

(73) Assignee: LifeYield, LLC, Boston, MA (US)

(21) Appl. No.: 13/468,198

(22) Filed: May 10, 2012

Related U.S. Application Data
(60) Provisional application No. 61/484,725, filed on May 11, 2011.
(60) Provisional application No. 61/611,099, filed on Mar. 15, 2012.

(51) Int. Cl. G06Q 40/06

(52) U.S. Cl. 705/36 T

(57) ABSTRACT

Computer-implemented methods for optimizing income sources in an investment portfolio over a specified course of years. Once input data concerning household income sources, investment assets, preferences and putative strategies have been received, sources of income available to the household in a first year are then optimized on the basis of a first set of simulation assumptions. Sources include social security, investment income, withdrawals from accounts, and annuity income. Iteration over a specified retirement period yields an optimized sequence of income, as well as recommended sources of income and investment allocations.

The present application claims the priority of U.S. Provisional Patent Application Ser. No. 61/484,725, filed May 11, 2011, and of U.S. Provisional Patent Application Ser. No. 61/611,099, filed Mar. 15, 2012, both of which applications are incorporated herein by reference.

### TECHNICAL FIELD

The present invention relates to integrative methods for optimizing sources of retirement income, and, more particularly, to methods for solving multi-period optimization problems.

### BACKGROUND ART

Households contemplating retirement are often overwhelmed with conflicting advice about how to manage sources of income, whether to purchase annuities and how to manage and make withdrawals from investment accounts. Households may have multiple sources of retirement income but can only spend such cash as is available, in a given year, after taxes have been paid. Considerations that go into the planning of income sources include: 1) income from earnings before retirement as well as retirement income (such as social security and pension payments); 2) income from annuity contracts (already purchased and to be purchased); and 3) investment portfolios with different types of tax treatments. Other considerations may include household demographics (age of members) and easily understood household preferences for (after tax and inflation) income and bequests.

Prior art methods provide for the calculation of Social Security payments and the pricing of annuities. It is known that annuity formulas may be used to determine how much can be withdrawn from investment accounts, income taxes may be calculated on the basis of existing, or prospective, tax brackets. However, in the prior art, these elements have only been employed in isolation, because it has been deemed impossible to combine them. Prior art methods separately frame preferences for each type of income, not to reflect individual behavior but to simplify the problem by separation into simpler problems.

The state of the art prior to the present invention is reflected in Report No. GAO-11-400 of the US Government Accountability Office, entitled Retirement Income: Ensuring Income throughout Retirement Requires Difficult Choices,” (June, 2011) (hereinafter, the “GAO Report”), which is incorporated herein by reference. The GAO Report relies on the recommendations of experts, indicating that prior to the present invention, there was no known analytic or numerical solution to the integrated problem of year-to-year sourcing of retirement income, and that recommendations could only be performed by a practiced financial advisor.

Calculation of the foregoing components of a retirement income strategy, in isolation and without integration, often leads either to an incomplete or incorrect recommendation. For example, a Social Security calculator can compare pretax payments based on different starting dates, but cannot compare after tax payments unless all sources of taxable income are estimated (and resulting tax brackets) over the retirement period. Income annuities can be easily priced (even including payments conditional on survival), but tax consequences of including them in tax deferred, tax free or taxable accounts cannot Annuity formulas to calculate sustainable withdrawals from investment accounts need to take into account anticipated uses of income tax brackets and tax management of investments in taxable accounts (for example substitution of municipal for taxable bonds). With predetermined taxable income in a single year, one can easily take into account (estimated) tax brackets.

However, with many income sources and ways of shifting taxable income between years (especially with taxable withdrawals from traditional IRA accounts), one needs to derive optimal rules for determining how to consistently use low tax brackets and avoid using high tax brackets. No method known prior to the present invention has been able to make a recommendation for purchasing an annuity contract in a taxable or IRA account. An invention which teaches rules of optimality and methods for achieving them in the face of the foregoing considerations would thus be of great value to the any retiree or prospective retiree.

### SUMMARY OF EMBODIMENTS OF THE INVENTION

In accordance with various embodiments of the present invention, computer-implemented methods are provided for optimizing income sources in an investment portfolio over a specified course of years, wherein the investment portfolio is represented by data on a storage medium and includes a plurality of accounts of a household. The methods have steps of:
a. receiving input data concerning household assets, preferences, and putative strategies;
b. optimizing sources of income available to the household in a first year from social security, asset income and withdrawals, and any annuities based on a first set of simulation assumptions and based on household assets and preferences and tax brackets for the first year;
c. iterating, over a specified retirement period, a calculation of income available to the household from social security, asset income and withdrawals, and any annuities based on the first set of simulation assumptions and based on household assets and preferences and tax brackets for each subsequent year to a specified termination to provide an annual calculated income;
d. repeating steps (b.) and (c.) for a specified number of simulations requiring calculations in excess of the capacity of humans to perform;
e. averaging the annual calculated income for each year over the specified number of simulations;
f. providing an aggregate optimized set of recommended cash flows from income sources and investment accounts and asset allocations based on an ensemble of simulated returns over the specified retirement period; and
g. outputting a summary of performance based on the putative strategies.

In accordance with alternate embodiments of the invention, a subset of the assets are designated as safe assets, and the step of optimizing sources of income may be based, in part, on specified constraints with respect to maintenance of enough safe assets to meet safe income goals. In further embodiments, resources may be allocated during a pre-retirement phase based in the putative strategies and in a post-retirement period to meet risky income goals for different periods.

In accordance with yet another embodiment of the invention, the computerized method has a further step of dynamically allocating assets among accounts during pre-retirement and post retirement phases based on designated allocations and bucket values for dedicated assets that provide risky income at a plurality of distinct horizons.

### BRIEF DESCRIPTION OF THE FIGURES

The foregoing features of the invention will be more readily understood by reference to the following detailed description, taken with reference to the accompanying figures, in which:

FIG. 1 shows a flowchart overview of processing steps that implement a preferred embodiment of the present invention.

FIG. 2 shows one embodiment of a general-purpose computer that may be used to implement aspects of the invention.

### DETAILED DESCRIPTION OF EMBODIMENTS OF THE INVENTION

Definitions: As used herein and in any appended claims, the term “household” refers to one or more individuals, referred to herein as “members,” treated under the laws of a specified jurisdiction as an integral entity for tax purposes. The term “first death” refers to the death that is first in time of the members of a household, while the term “second death” refers to the death that is second in time of the members of a household.

The term “investment portfolio,” as used herein and in any appended claims, refers to an aggregation of investment accounts managed as a unit.

The terms “account,” and “subaccount” as used herein and in any appended claims, refer to a defined aggregation of assets pertaining to one or more members of a family unit, the assets including, without limitation, securities, commodities, annuities, pensions, real estate, and cash, all managed as a unit.

An asset may be said to be part of an account when it is either held within the account or else considered as a candidate for acquisition for the account.

Some assets may be designated as “safe” assets, employing standards common in the profession of financial management. Some sources of income such as annuities and Social Security may involve guarantees as to the level of future payments.

A “bucket,” as used herein and in any appended claims, shall mean an aggregation assets dedicated to providing income during a specified period. A bucket is preferably defined by three characteristics:
an income period, such as the period 2025-2030;
a current value, such as $250,000; and
a target allocation, such as 25% equity and 75% bonds.
   A bucket consists of assets dedicated to providing income in a particular period. The justification for separate buckets is so they can have different target allocations, which determine what the expected level and range of income will be for the period. With the assets dedicated to supporting safe income (in excess of that provide by safe income sources), it would not necessarily require separate buckets for different time periods because there is the same target allocation (just AA bonds) for each horizon. Buckets do not require separate accounts, rather accounting for assets across the clients' IRA and taxable investment accounts.

The term “dynamically allocating assets” shall mean “redetermining the association of specified assets with specified subaccounts at intervals of time which may be, but need not be, fixed.”

The term “bucket value,” as used herein and in any appended claims, shall refer to a fraction of the value of an entire portfolio, or of a specified portion thereof, sharing the characteristic attributed to the bucket in question. To use buckets, values are assigned to them and then updated through time (until they are paid out).

“Safe income” shall mean any income derived from investments equivalent, in terms of risk, to a bond having a credit quality rating of ‘AA’ or better.

“Risky income” shall mean any income derived from investments which include some assets with risk greater than a bond having a credit quality rating of ‘AA.’

“Horizon” shall refer to the length of time that a portfolio or a distinct investment is intended to be maintained, as the context may require.

In accordance with embodiments of the present invention, household assets are include: 1) income from earnings before retirement as well as retirement income (such as Social Security and pension payments); 2) income from annuity contracts (already purchased and to be purchased); and 3) investment portfolios with different types of tax treatments. Embodiments of the invention also take into account household demographics (age of members) and easily understood household preferences for (after tax and inflation) income and bequests. Income preferences may be satisfied by both income sources and investment accounts.

In accordance with preferred embodiments of the present invention, the multiple period problem extending from the household's current circumstances (before or during retirement) is collapsed into a sequence of solvable single period problems, which anticipate subsequent decisions and potential range of after tax income over the household's long retirement period. Although the invention is described as embedded in a multiple period Monte Carlo simulation, the actions recommended at the beginning period may be implemented immediately by the household. Actions recommended in subsequent periods in the simulation illustrate actions, which the household should take in similar circumstances.

For households before retirement, the invention teaches how to rebalance the household's investment accounts taking to account current use of tax brackets and anticipated use of tax brackets for withdrawals from their IRA accounts. The invention may also recommend how much households should contribute to their taxable accounts after satisfying its needs for after tax income.

For households in transition after one member has retired but before the last reaches age 70, the invention teaches when to start Social Security, how to allocate investments to achieve safe and risky income goals and how much to convert from traditional IRA to Roth IRA. The invention also teaches how much to withdraw in after tax income, from what accounts and annuities to make withdrawals.

For households at the beginning of the long income phase of retirement, the invention also teaches how much (if any) to purchase of income annuities (as well as in what type of accounts) to satisfy needs for guaranteed income. For households in any year of the income phase of retirement, the invention teaches how to source income from Social Security and pensions as well as annuities and investment accounts. The invention also teaches how much to take in after tax investment income from guaranteed, safe and risky sources as well as how to allocate and locate assets across investment accounts. The invention provides the convenience of embedding current decisions across diverse income sources and investments in a single set of algorithms and ensures the consistency of actions through time, resulting in increased income and bequests for the households. Finally, feedback about probable actions in later periods can allow the household a preview of what decisions will need to be made when.

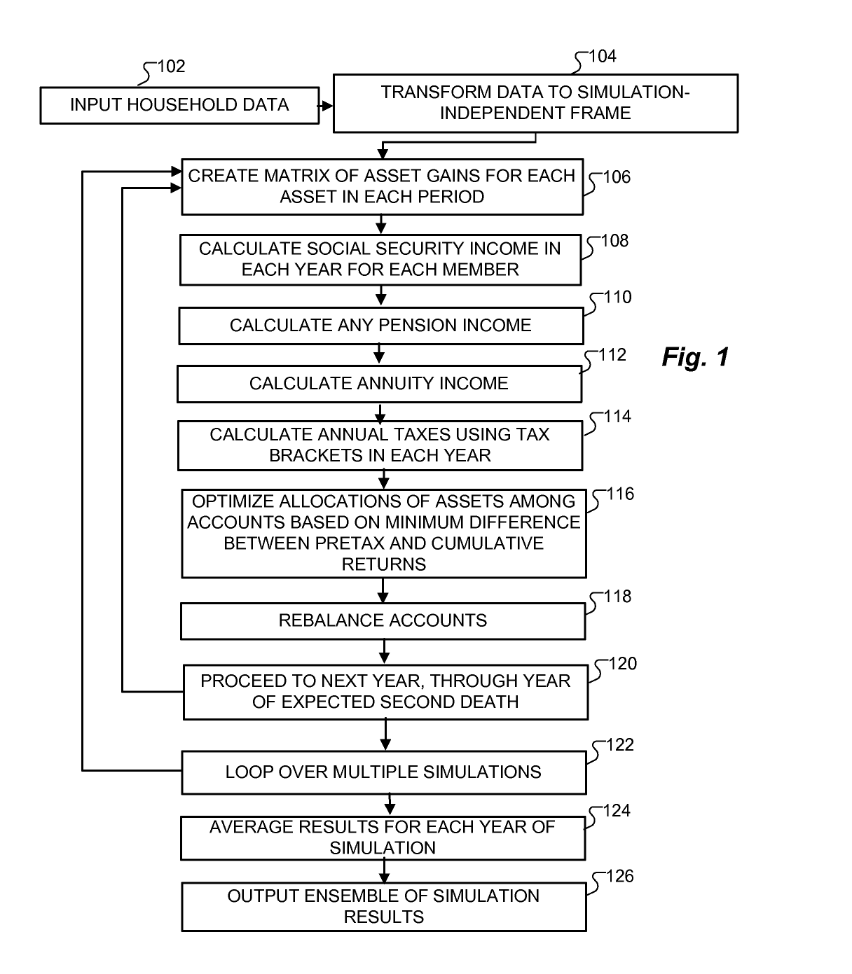

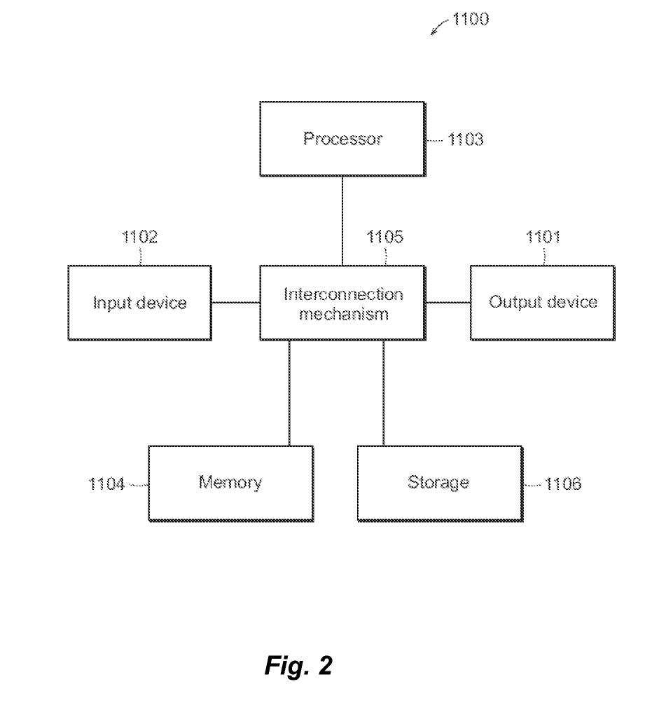

The way the foregoing is performed, in accordance with embodiments of the present invention, is now described with reference to the flowchart depicted in FIG. 1. In an input collection step 102, the following inputs are collected and stored in memory device 1504 (shown in FIG. 2).
1) External inputs, which do not depend on a particular household, including, for example, and without limitation:
   a. Tax brackets and rates:
   b. Standard deduction table
   c. Mortality table
   d. Asset Expected Returns
   e. Asset covariance matrix for Equity, Taxable and Tax Free Fixed Income Gains
   f. Expected Inflation
   g. Number of Simulations to be used
2) Inputs concerning the members of a household including ages, planned retirement and earnings.
3) Inputs about the household assets, including investments, annuities, etc.
4) Inputs concerning household preferences, including income before first retirement, minimum after-tax after-inflation income in first, transition, and subsequent retirement phases, including, in certain embodiments of the invention, after-tax income from guaranteed, safe and risky sources, which may be defined by time periods.

Following the collection of inputs, the following multiple-period problem is posed:
a. The multiple-period problem to be solved maximizes after tax income (consistent with investor preferences) from all income sources, annuities and investments during retirement, leaving a maximum bequest at the unknown time of the last death of household members. The problem is solved for a single simulation by taking actions (once a year or at an appropriate frequency), which sufficiently anticipate future actions. The innovation focuses on creating tractable actions in each year, which in sequence maximize income consistent with household assets and preferences. The actions recommended immediately can be implemented by the household.
b. For households with members before retirement, there are three phases: 1) Pre-retirement before either working member retires, 2) transition after one has retired but before the younger member reaches age 70; and income, extending through the longest probable survival of at least one member (until the youngest member reaches age 100). The actions taken differ in each period, although certain actions are repeated from period to period.

In accordance with the present invention, the foregoing multi-period problem is provided with a closed-form probabilistic solution, using the processes now described.

Monte Carlo simulations of asset returns are used to capture a broad range of market conditions. Averaging of subsequent results provides a basis for evaluating the optimality of actions. As used herein and in any appended claims, the term “action” refers to a decision made with respect to a purchase or a sale of an asset or a decision made regarding how to create or use cash flows from investments and other income sources. After tax income and remaining assets in each year are averaged across simulations. Average after tax income in each phase is averaged, either assuming a fixed evaluation period (such as the date of the second death) or probability weighted based on probability of survival of at least one member. Average bequests can be evaluated based on a fixed evaluation period or probability weighted based on the probability of second death in each year.

The solution for a particular household is begun by transforming inputs into intermediate values (in step 104), in a simulation-independent frame, which do not depend on a particular simulation. Thus, for example, calendar years are translated to a fiducial reference frame based on the retirement of the first member of a household to retire (a time that may be referred to herein as the “first retirement.”

As used herein, a period may be referred to, without limitation, as a “year,” based on common accounting principles.

Potential income sources are then assessed for each account for a first year. Examples include creating a matrix of asset gains (106) for each asset for each period within a specified range, such as a range of years from first retirement to anticipated second death. Similarly, Social Security income is computed (108) for each year of the specified range for each member of the household. Additionally, any pension income (110) and annuity income (112) is calculated under the specified set of assumptions. The foregoing income sources are provided by way of example, only, and any income sources (such as full- or part-time employment) may be included, within the scope of the present invention.

Annual taxes are calculated (114) using tax brackets appropriate for the particular year, and, on the basis of the foregoing calculations, and subject to household parameters, preferences, and assumptions made, allocation of assets is performed among accounts (116). Some subset of assets may be designated as safe assets, and allocation of assets may be subject to specified constraints, including sufficiency of safe assets to provide a specified level of income to the household per year. Methods of asset allocation among accounts, based, for example, on minimizing differences between pretax and cumulative returns, may be based on the teachings of copending U.S. patent application Ser. No. 12/545,969, filed Aug. 24, 2009, and entitled “Computer-Implemented Holistic Portfolio Management of Multiple Investment Accounts,” which is incorporated herein by reference.

Based on the foregoing considerations, household accounts are rebalanced (118), taking tax considerations into account. The same analysis is then applied (120), year by year, to successive years of a specified retirement period. The number of calculations associated with a single simulation could not be performed by humans within a reasonable time frame. The number of calculations performed over a large number of simulations could not be performed by humans. After a large number of simulations (122), the results are averaged (124) for each year of the simulation, and the ensemble of simulation results is output (126), as by displaying a graph, for example. On the basis of the foregoing calculations, various sets of algorithms for determining actions may be compared.

One issue that may be addressed by application of embodiments of the present invention includes the need of a household to know how much to “discount” current holdings in traditional IRA accounts based on the expected average tax bracket associated with withdrawals in retirement. Prior art is casual about this calculation, sometimes assuming no discount (and no taxes on withdrawals) or large discounts (consistent with the current year's high earnings and use of high tax brackets). In accordance with embodiments of the present invention, an accurate estimate of how much to discount current holdings in traditional IRA accounts is provided using the following novel algorithm, thereby allowing the household to concentrate some assets in the traditional IRA account (to reduce current taxes) without distorting its asset allocation.

In accordance with some embodiments of the present invention, a method is provided for producing an accurate estimate of how much to discount current holdings in traditional IRA accounts. Steps in accordance with that method include the following:
2) Discount IRA accounts by average tax rate for withdrawals (HH.IRARate)
3) Prioritize allocations to taxable account based on minimum difference between pretax and cumulative returns over preretirement period using expected gains and yields and preretirement tax rate: HH.PreTaxRate
   a Innovation involves incorporation of all income and tax brackets in estimates
   b. Substitution of tax exempt for taxable bonds based on comparison of implied tax rate and estimated tax rate
      i. Assign tax lots for each position in taxable account
      ii. Prioritize allocations to IRA accounts based on lowest combination of expected gain and yield
      iii. Relevant if Roth accounts are available
      iv. Minimizes use of higher tax brackets
      v. Note: except for more accurate estimates of current tax rates and withdrawal tax rates, innovations follow those taught in pending U.S. patent application Ser. No. 12/545,969 (to Samuelson, filed Aug. 24, 2009), which is incorporated herein by reference.
4) At the end of the first year and for all subsequent years of each phase of retirement
   a. Calculate value of each asset in each account based on asset gains: Asset.Value(iS,iA)
   b. Calculate income based on yields: HH.Inc(iY,iA)
   c. Calculate income from non-investment account sources: HH.ActOtherInc(iY)
   d. Calculate taxes before rebalancing: HH.ActTax(iY)
   e. If in preretirement phase:
      i. If taxable contributions are assigned, then
         1. Calculate after tax income: HH.AftTaxInc(iY)=HH.Inc(iY)+HH.ActOtherInc(iY)−HH.ActTax(iY)−HH.IRAContr(iY)−HH.TaxContr(iY)
      ii. Or Calculate contribution to taxable account: HH.TaxContr(iY)=HH.AftTaxInc(iY)−(HH.Inc(iY)+HH.ActOtherInc(iY)−HH.ActTax(iY)−HH.IRAContr(iY))
   f. Calculate revised account values: HH.AcctValue(iY,iA) consistent with contributions and asset values
   g. Calculate revised index values for indexed annuities based on allocations and asset returns
   h. Calculate revised values for Variable Annuities based on allocations and asset returns
   i. If in pre-retirement phase, rebalance accounts to target pre-retirement allocations
      i. In rebalance process repeat steps in 2 and 3
   j. If in transition or retirement phase, calculate allocation to safe investments and asset allocation for risky investments for income at different periods
      i. If first year of transition and investor has preferences for income defined by separate periods, calculate Net Present Value (NPV) of providing expected income for each period, using expected returns (blended between after tax and pre-tax returns based on mix of tax deferred, tax free and taxable accounts) for target asset allocation;
         1. Assign initial values for each risky bucket, HH.RiskAsset(iY,iB), by allocating value of investment accounts net of value of safe assets in proportion to each bucket's NPV.
      ii. If after first year of transition and employing separate buckets, calculate bucket value based on prior value and estimated after tax return to target allocation.

During the transition to retirement, how to replace declines in earned income, when to start sources of retirement income such as Social Security and pensions, and how much to transfer between traditional and Roth IRA accounts are all rigorously calculated, in accordance with novel algorithms as laid out in detail below. As suggested above, prior art makes recommendations on these decisions in isolation and often provides incorrect recommendations. A household with diminished earnings and at least one member below 70 years has maximum flexibility in determining sources of taxable income and spending.
a. At end of first year and other years of transition period
   i. Estimate sustainable annual after tax and inflation income from all income sources including Social Security, pensions and annuities
      1. Based on expected returns and expected average tax rate based on use of tax brackets in each year
      2. Compare for each eligible member, income associated with beginning Social Security now and beginning at age 70
         a. If sufficient income is available from investment accounts or annuities to meet safe income goal, then delayed Social Security payments will be greater than immediately starting them
         b. If no IRA conversions are available, then immediate Social Security may be greater because there are unused deductions and low tax brackets
         c. Begin Social Security for member if age 70
         d. Recommend application for spousal benefit if applicable and neither has begun Social Security
   ii. With available taxable assets and after tax income, withdraw income to meet safe income goal and sustainable income from risky assets:
      1. Adjust amount taken by difference between current income from sources and sustainable income: for example if Social Security has not started, adjustment will be positive
      2. Sustainable income from risky investments is calculated as taught in pending U.S. patent application Ser. No. 12/545,969 (to Samuelson, filed Aug. 24, 2009), which is incorporated herein by reference.
      3. Sustainable income may come from current risky bucket if risky assets are allocated to different retirement periods.
         a. Use annuity formula to determine how much to withdraw from bucket.
   iii. Based on remaining tax bracket capacity in current year, determine voluntary withdrawal from IRA accounts:
      1. Innovations:
         a. Don't use IRA withdrawals for income or to pay taxes but instead make (partial) conversion to Roth IRA
         b. Compare use of current bracket to future use of brackets
         i. If financed by taxable account (usually case), then adjust future tax rates for each bracket by difference between cumulative pretax and after tax returns (based on asset allocation to taxable account
         c. Properties of optimal solution:
         i. Either make no voluntary withdrawal because enough capacity at low bracket is available (very rare)
         ii. Make voluntary withdrawals to use up remaining capacity of particular tax bracket (common)
         iii. Make voluntary withdrawals to use up part of remaining capacity of tax bracket(very rare)
         iv. Note: other approaches to Roth conversions provide incorrect advice (or correct advice based on the wrong reason: a broken clock tells correct time twice per day)
   iv. Pay taxes from taxable account on additional withdrawal
b. Determine allocation to safe assets (HH.SafeAsset(iY), to be invested in fixed income) if household has minimum safe income goal (HH.SafeInc)
   i. Estimate pretax income from all safe sources in each year: HH.ExpSafeInc(iY)=HH.SSInc(iY)+HH.PensInc(iY)+HH.FxAnnInc(iY)+HH.IdxFI*HH.IdxAnnUnit(iY)+HH.VAMinWth(iY)
   ii. Estimate taxes on all safe sources using tax bracket calculation HH.ExpSafeTax(iY)
   iii. Calculate shortfall in each year: HH.SafeAnnInc(iY)−(HH.ExpSafeInc(iY)−HH.ExpSafeTax(iY)
   iv. Using average after tax fixed income return, calculate HH. SafeAsset(iY)=sum(HH. HH.SafeAnnInc(iY)/(1+AftTaxFI)̂iY
c. Determine allocation to one (or more) bucket(s) for risky assets
   i. For each bucket, determine value of risky assets: HH.RiskAsset(iY,iB)
   ii. For each bucket, use post retirement allocations: HH.RetEq(iB) and HH.RetFI(iB)

In the income phase of the retirement period (after the younger member turns 70), all sources of retirement income (such as Social Security) will have been initiated. At the beginning of first year of income period, determine if purchase of income annuities with fixed payments, HH.FxAnnPurch(iY) is necessary to meet guaranteed income goal HH.GuarAnnInc(iY)
i. As in process of b.1 through b.4 for safe income, estimate gap in guaranteed income in each year: HH.GuarIncGap(iY)=HH.GuarInc(iY)−(HH.ExpGuarInc(iY)−HH.ExpGuarTax(iY))
ii. Use formula to estimate purchase price of annuity:
   1. HH.FxPurch(iY)=sum(HH.GuarIncGap(iY)*PrSurv(iY))/(1+A sset.FIReturn)̂iY
   2. One is replicating purchase price of annuity with fixed payments but discounting cost of payments in period beyond guarantee by probability of survival of at least one member: PrSurv(iY)
iii. Assign annuity purchases to IRA first (because payments are consistent with desired withdrawals from IRA, then Roth, then taxable account

In each year of income phase, determine target income from safe and risky investments in same manner as in income phase
a. Taking into account difference between current after tax income from guaranteed and safe sources versus the sustainable level
b. Determine amount to withdraw from traditional IRA accounts based on
   i. Required Minimum Distribution
   ii. Available capacity in current tax brackets versus anticipated use of future tax brackets iii. Note: process for determining voluntary withdrawals is same as in transition period, but there is a much higher probability that the optimal solution may involve no voluntary withdrawals or use of lower tax bracket than in transition.
   iv. Although many approaches will recommend complete conversion of traditional IRA accounts (resulting in unnecessary use of higher tax brackets), our approach will not
c. Other steps same as in transition phase

Embodiments of the present invention, as described above, may be used advantageously to determine how to invest risky assets in one or more buckets in the transition and retirement periods, as well as to provide a recommendation concern the level of sustainable after tax income from the current bucket. They may adjust the current period's income recommendation for differences between current income from Social Security and its average over subsequent years.

In the long retirement period, embodiments of the present invention may be used to recommend the sourcing for income and (if relevant) purchases of annuities from investment accounts. While the pattern of withdrawals and adjustments to investment allocations may be more predictable and repetitive from year to year, its cumulative impact over many years can determine whether a household has satisfactory financial resources in retirement.

Embodiments of the present invention, as described above, may advantageously assist a household in making consistent use of low tax brackets and maintaining the necessary allocation to safe investments to produce (along with other safe income sources) the household's income cushion. Embodiments of the present invention, as described above, may advantageously recommend the sourcing of withdrawals, often involving a consistent level from the traditional IRA account and exhaustion of the taxable accounts before withdrawing from the Roth accounts.

Embodiments of the present invention, as described above, may advantageously take into account the use of higher tax brackets, if withdrawals from the traditional IRA account arise with more favorable investment returns.

Various embodiments according to the invention may be implemented on one or more computer systems. These computer systems, may be, for example, general-purpose computers. It should be appreciated that one or more of any type computer system may be used to perform some or all of the steps of the embodiments described herein. Further, the software design system may be located on a single computer or may be distributed among a plurality of computers attached by a communications network.

Various aspects of the invention may be implemented as specialized software executing in a general-purpose computer system 1100 such as that shown in FIG. 2. The computer system 1100 may include a processor 1103 connected to one or more memory devices 1104, such as a disk drive, memory, or other device for storing data. Memory 1104 is typically used for storing programs and data during operation of the computer system 1100. Components of computer system 1100 may be coupled by an interconnection mechanism 1105, which may include one or more busses (e.g., between components that are integrated within a same machine) and/or a network (e.g., between components that reside on separate discrete machines). The interconnection mechanism 1105 enables communications (e.g., data, instructions) to be exchanged between system components of system 1100. Computer system 1100 also includes one or more input devices 1102, for example, a keyboard, mouse, trackball, microphone, touch screen, and one or more output devices 1101, for example, a printing device, display screen, speaker. In addition, computer system 1100 may contain one or more interfaces (not shown) that connect computer system 1100 to a communication network (in addition or as an alternative to the interconnection mechanism).

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 1100 is shown by way of example as one type of computer system upon which various aspects of the invention may be practiced, it should be appreciated that aspects of the invention are not limited to being implemented on the computer system as shown in FIG. 2. Various aspects of the invention may be practiced on one or more computers having a different architecture or components than that shown in FIG. 2.

Computer system 1100 may be a general-purpose computer system that is programmable using a high-level computer programming language. Computer system 1100 may be also implemented using specially programmed, special purpose hardware. In computer system 1100, processor 1103 is typically a commercially available processor. The processor typically executes an operating system.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate, or interpreted code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described various illustrative embodiments of the present invention, some of its advantages and optional features, it will be apparent that such embodiments are presented by way of example only and are not by way of limitation. Those skilled in the art could readily devise alternations and improvements on these embodiments, as well as additional embodiments without departing from the spirit and scope of the invention. All such modifications are within the scope of the invention as claimed. The described embodiments of the invention are intended to be merely exemplary and numerous variations and modifications will be apparent to those skilled in the art. All such variations and modifications are intended to be within the scope of the present invention as defined in the appended claims.

1. A computer-implemented method for optimizing income sources in an investment portfolio and other income sources over a specified course of years, wherein the investment portfolio is represented by data on a storage medium and includes a plurality of accounts of a household, the method comprising:
a. receiving input data concerning household assets, preferences and putative strategies;
b. optimizing sources of income available to the household in a first year from social security, asset returns, and any annuities based on a first set of simulation assumptions and based on household assets and preferences and tax brackets for the first year;
c. iterating, over a specified retirement period, a calculation of income available to the household from social security, asset income and withdrawals, and any annuities based on the first set of simulation assumptions and based on household assets and preferences and tax brackets for each subsequent year to a specified termination to provide an annual calculated income;
d. repeating steps (b.) and (c.) for subsequent sets of simulation assumptions for a specified number of simulations that exceeds the capacity of humans to perform the specified number of calculations;
e. averaging the annual calculated income for the first year and each subsequent year over the specified number of simulations;
f. providing an aggregate optimized set of allocations based on an ensemble of simulated returns over the specified retirement period; and
g. outputting a summary of performance based on the putative strategies.

2. A computerized method in accordance with claim 1, wherein a subset of the assets are designated as safe assets and subsets of income sources are designated as guaranteed or safe, and the step of optimizing sources of income is based, in part, on specified constraints on assets in order to maintain safe income from income sources and assets.

3. A computerized method in accordance with claim 1, further comprising dynamically allocating assets among accounts during pre-retirement and post retirement phases based on designated allocations and bucket values for dedicated assets providing risky income at a plurality of distinct horizons.
